(19) United States
(12) Patent Application Publication
(10) Pub. No.: US 2002/0161574 A1
(43) Pub. Date: Oct. 31, 2002

(54) Speech recognition system, training arrangement and method of calculating iteration values for free parameters of a maximum-entropy speech model

(76) Inventor: Jochen Peters, Aachen (DE)

Correspondence Address: U.S. Philips Corporation, 580 White Plains Road, Tarrytown, NY, 10591, US

(21) Appl. No.: 10/075,866

(22) Filed: Feb. 13, 2002

(30) Foreign Application Priority Data
Feb. 13, 2001 (DE) 10106580.9

(51) Int. Cl. G10L 19/10

(52) U.S. Cl. 704/220

(57) ABSTRACT

The invention relates to a speech recognition system and a method of calculating iteration values for free parameters λα of the maximum entropy speech model. In the state of the art it is known that these free parameters λα can be approximated cyclically and iteratively, for example, using a GIS training algorithm. Cyclically in this case is understood to mean that for each iteration step n a cyclically predefined attribute group Ai(n) of the speech model is evaluated in order to calculate the n+1 iteration value for the free parameters. An attribute group Ai(n) with such a rigid cyclical assignment is not always the best solution, however, for ensuring the fastest and most effective convergence of the GIS training algorithm in a given situation. Therefore, a method is proposed in the context of this invention, which will assist at choosing the attribute group that is the most suitable in this respect, while the degree of adaptation of iteration boundary values m_{α}⁽ⁿ⁾ to respective associated and desired boundary values mα for all attributes of the relevant attribute group serves as a criterion for choosing the attribute group.

The invention relates to a method of calculating iteration values for free parameters λ in the maximum-entropy (ME) speech model, in accordance with the introductory part of patent claim 1.

The invention further relates to a speech recognition system and a training arrangement in which a method of this kind is implemented.

In the state of the art it is known that in a (ME) speech model so-termed free parameters λ must be defined or trained. One known algorithm for training these free parameters λ is the so-termed Generalized Iterative Scaling (GIS) training algorithm. Several variants of this GIS training algorithm are known; the invention set out herein relates, however, only to a cyclical variant in which free parameters λ are calculated iteratively as follows:

$${λ}_{α}^{( n + 1 )} = {λ}_{α}^{( n )} + {t}_{α} \cdot log ( \frac{{m}_{α}}{{m}_{α}^{( n )}} \cdot \frac{1 - {\sum }_{βϵ {A}_{n ( modm )}} {t}_{β} \cdot {m}_{β}^{( n )}}{1 - {\sum }_{βϵ {A}_{n ( modm )}} {t}_{β} \cdot {m}_{β}} ) \qquad ( 1 )$$

In this cyclical variant, each iteration value n is assigned an attribute group Ai, where i=n(mod m), from a total of m attribute groups in the speech model, and the iteration values λ_{α}⁽ⁿ⁺¹⁾ calculated separately for all attributes α from the currently assigned attribute group Ai before the iteration parameter n is incremented by 1. This cyclical variant of the GIS training algorithm is published, for example, in J. N. Darroch and D. Ratcliff, “Generalized iterative scaling for log linear models”, Annals Math. Stat., 43(5):1470-1480, 1972.

In the formula (1), the terms have the following meaning:

n: The iteration parameter;

m: The number of all the predefined attribute groups in the speech model;

An(mod m): The attribute group which is currently assigned to the iteration parameter n;

α: A specific attribute from the attribute group An(mod m);

β: All attributes from the attribute group An(mod m);

λ_{α}⁽ⁿ⁾: The n-th iteration value for the free parameter λα;

tα, tβ: Convergence increments;

mα, mβ: Desired boundary values in the speech model; and

m_{α}⁽ⁿ⁾, m_{β}⁽ⁿ⁾:nth iteration boundary values for the desired boundary values mα and mβ, respectively.

A few of the parameters listed above from formula (1) are explained in more detail below:

The cyclical variant of the GIS training algorithm shown in formula (1) is based on the idea that all the attributes predefined in the ME speech model are assigned to individual attribute groups Ai, of which a total of m are defined in the speech model. An example of a speech model with a total of m=3 predefined attribute groups Ai, where i=1 . . . 3, is shown in FIG. 5. Attributes can generally represent individual words, strings of words, classes of words, strings of classes of words, or more complex patterns. In FIG. 5, attribute group A1 contains words, e.g. the word “House” and strings of words such as “The Green”. In contrast, the attribute group A3 contains individual classes of words, such as “adjective” or “noun” and strings of classes of words, e.g. “adverb-verb”.

For the known cyclical calculation of the free parameters λα shown in formula (1), a modulo-m attribute group Ai=An(mod m), is permanently assigned to each iteration parameter n. This rigid cyclical assignment has the following disadvantage:

It leaves no room for a specific adaptation of the GIS training algorithm to the various attribute groups in which there is still a strong need for correction. It may therefore be that, in a subsequent iteration step, iterative boundary values which in a previous iteration step had already been effectively adapted to the assigned desired boundary value, do not require any major λ corrections. The correction of other parameters would be advantageous in this instance.

With the traditional cyclical variant, an unnecessarily high number of iteration steps are carried out for obtaining a good estimate of the desired boundary values and the desired free parameters λ.

Based on this current state of the art, the task of the invention is to develop a speech recognition system, a training arrangement and a method of calculating iteration values for free parameters λ of the ME speech model to a point where the iterative calculation will be faster and more effective.

This object is achieved by the method set out in patent claim 1.

Using this method, the object is achieved by the fact that the respective attribute group Ai(n), with 1≦i(n)≦m, is assigned to the current iteration parameter n, for which, in accordance with a predefined criterion, the adaptation of the iteration values m_{α}⁽ⁿ⁾ to the respective associated desired boundary values mα is the worst of all the m attribute groups of the speech model.

As this invention assigns attribute groups Ai(n) to individual iteration parameters/iteration steps n, a better convergence behaviour of the GIS training algorithm is achieved for approximating the free parameters λ. The iterative calculation of the free parameters λ should now no longer be labelled as cyclical, since the assignment of attributes group Ai(n) to the iteration parameter n no longer takes place cyclically, but instead occurs in accordance with a criterion that is calculated separately. Compared to the cyclical version, this acyclical calculation according to this invention has the advantage of enabling a faster and more effective calculation of the desired iteration values for the free parameters λ.

According to the first example of embodiment of the invention as claimed in patent claim 2, the criterion for selecting the most suitable attribute group Ai for the iteration parameter n is calculated before each incrementation of the iteration parameter n in accordance with the following equation:

$${D}_{i}^{( n )} = [ {\sum }_{αϵ {A}_{1}} {t}_{α} \cdot {m}_{α} log ( \frac{{m}_{α}}{{m}_{α}^{( n )}} ) + ( 1 - {\sum }_{αϵ {A}_{i}} {t}_{α} \cdot {m}_{α} ) log ( \frac{1 - \sum {t}_{α} \cdot {m}_{α}}{1 - \sum {t}_{α} \cdot {m}_{α}^{( n )}} ) ]$$

The index of the selected attribute group is then defined as follows:

$$i ( n ) = arg {max}_{j} {D}_{j}^{( n )}$$

The GIS training algorithm for the iterative calculation of the free parameters λ—and with it the mathematical function G( ) in patent claim 1—is advantageously as follows:

$${λ}_{α}^{( n + 1 )} = G ( ) = {λ}_{α}^{( n )} + {t}_{α} \cdot log ( \frac{{m}_{α}}{{m}_{α}^{( n )}} \cdot \frac{1 - {\sum }_{β ∈ Ai ( n )} {t}_{β} \cdot {m}_{β}^{( n )}}{1 - {\sum }_{β ∈ Ai ( n )} {t}_{β} \cdot {m}_{β}} ) , \qquad \text{(1a)}$$

where this algorithm is in essence familiar from the state of the art and has been described above as formula (1). As in the cyclical version, the free parameters λα are adapted as shown in formula 1a. Here, all attributes α of the selected group Ai(n) are processed.

It is advantageous for calculating the criterion Dᵢ⁽ⁿ⁾ and the free parameters λ in accordance with the GIS training algorithm if a special attribute function fα is used—i.e. preferably an orthogonalized attribute function ƒ_{α}^{ortho}.

Using the orthogonalized attribute function ƒ_{α}^{ortho}generally effects an improvement in the convergence speed of the GIS training algorithm. Using the orthogonalized attribute function in the process covered by the invention gives rise to a further increased convergence speed for the GIS training algorithm.

Further advantageous variations and applications of the process according to the invention form the object of the dependent claims.

The object of the invention is also accomplished by a speech recognition system and a training arrangement based on the maximum entropy speech model, as claimed in patent claims 8 and 9. The advantages of this speech recognition system and the training arrangement are the same as those discussed above for the method according to the invention.

These and other aspects of the invention are apparent from and will be elucidated, by way of non-limiting example, with reference to the embodiments described hereinafter.

In the drawings:

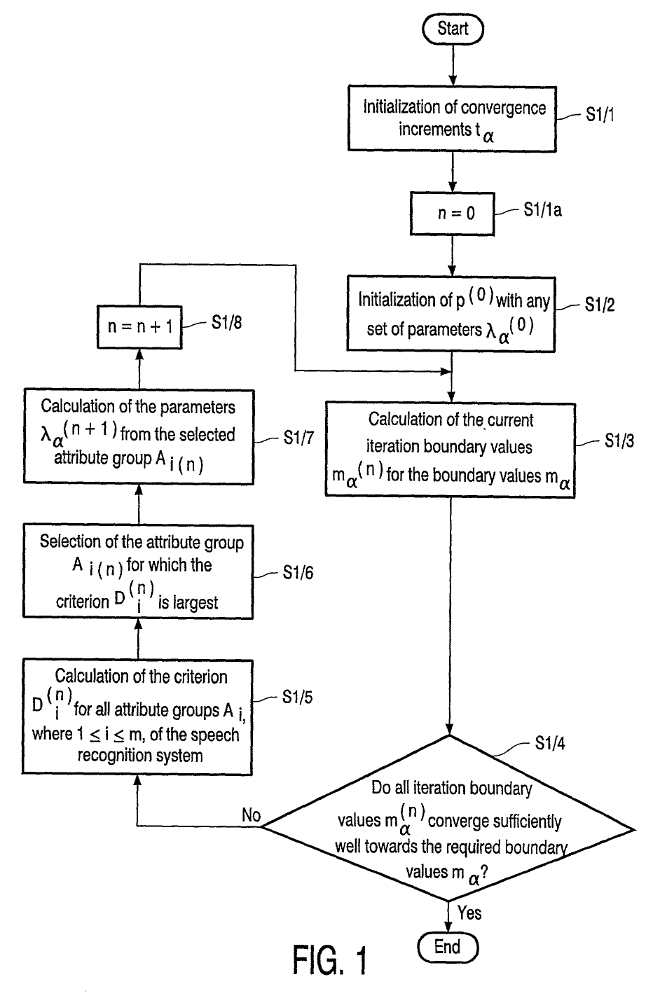

FIG. 1 shows a flowchart for calculating the criterion for selecting a suitable attribute group Ai(n) for an iteration parameter n in accordance with the present invention;

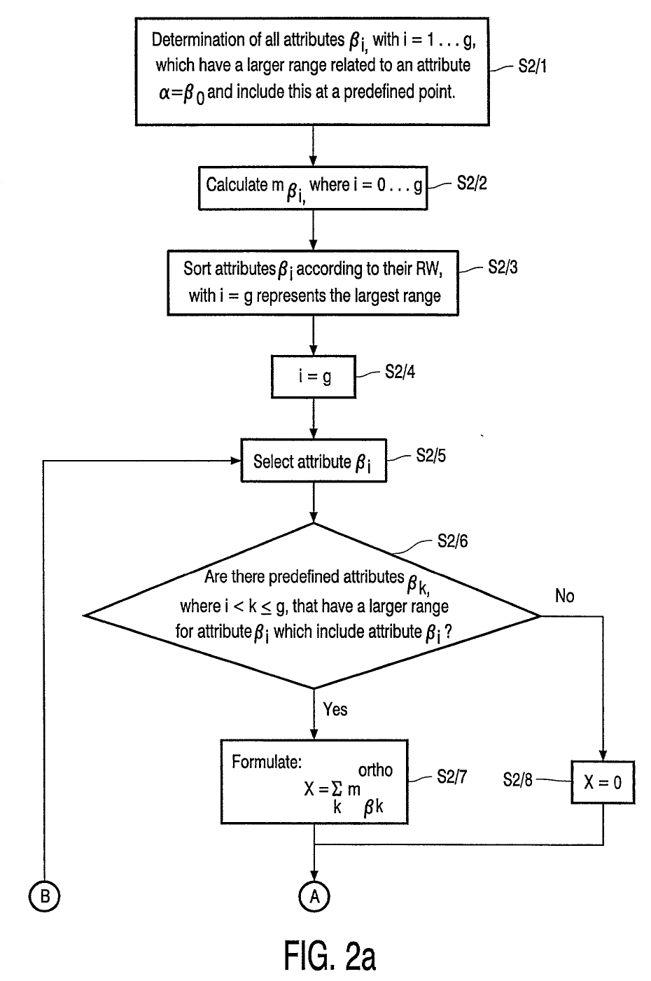

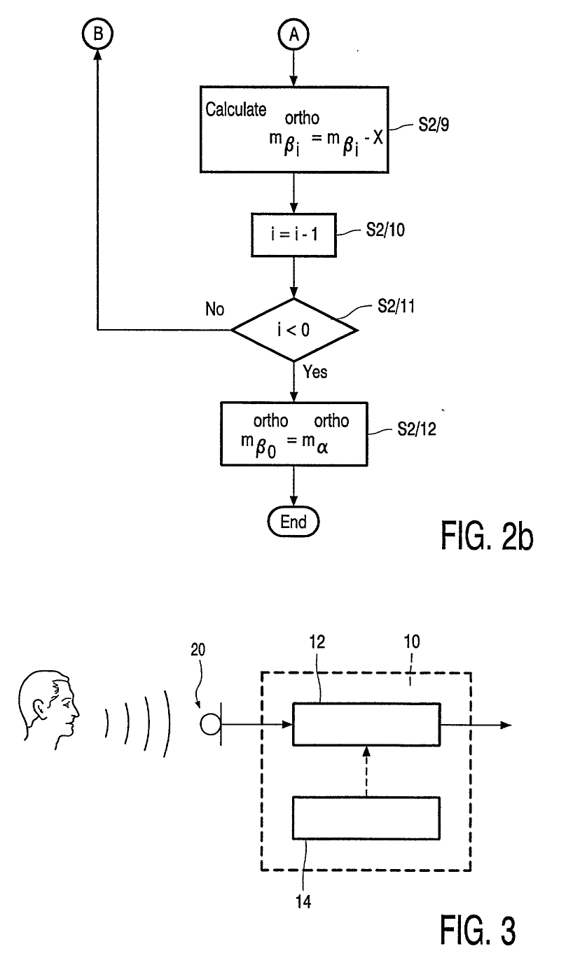

FIG. 2 shows a method of calculating an improved orthogonalized boundary value m_{α}^{ortho};

FIG. 3 shows a speech recognition system in accordance with the present invention; and

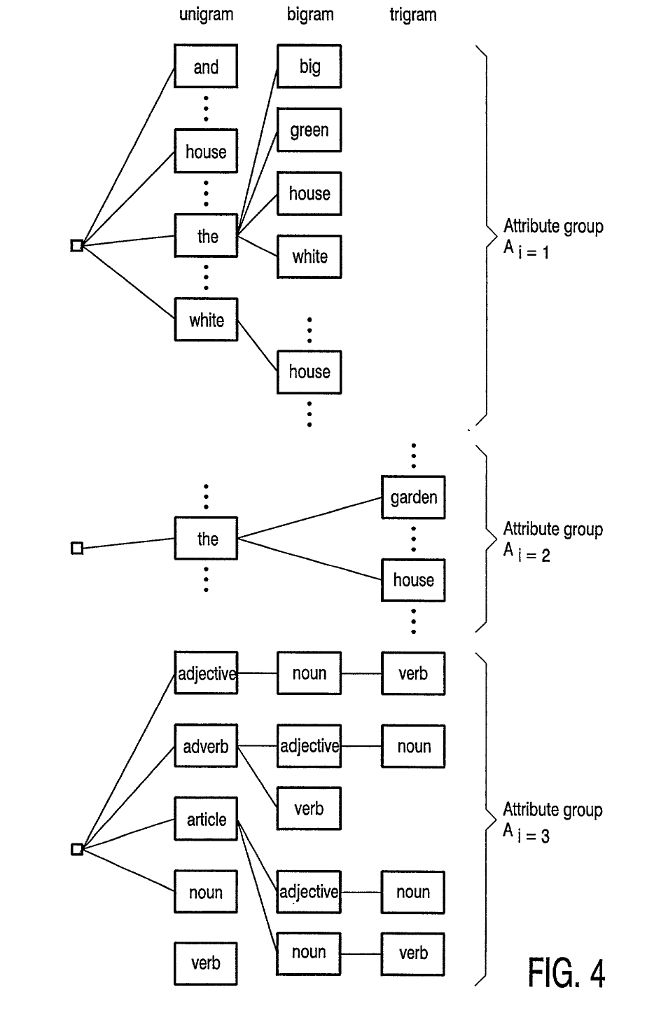

FIG. 4 shows an example of attribute groups in a speech model (state of the art).

FIG. 1 illustrates the individual method steps of a method according to the invention for the selection of the attribute group Ai(n) that is the most suitable for calculating iteration values λ_{α}⁽ⁿ⁺¹⁾in accordance with the GIS training algorithm.

The method shown in FIG. 1 provides that, in an initial method step S1/1, convergence increments tα must first be initialized. In step S1/1a, the iteration parameter n=0 is set.

Further, the probability p(0) must be initialized with any set of starting parameters λ_{α}⁽⁰⁾. Here, p(0)(w|h) represents a suitable initialization or starting value for the probability that a word w follows a previous string of words h (history)(S1/2).

In method step S1/3, the current iteration boundary values m_{α}⁽ⁿ⁾must be calculated for their respective associated desired boundary values mα, which ultimately define the desired speech model, and indeed for all attributes α that are predefined in the speech model.

The desired boundary values mα define the following boundary conditions for the desired probability distribution p(w|h):

$${\sum }_{( h , w )} N ( h ) \cdot p ( w \vert h ) \cdot {f}_{α} ( h , w ) {=}^{!} {m}_{α} , \qquad ( 2 )$$

where

N(h): represents a frequency of history h;

p(w|h): represents the probability that the word w follows the history h; and

fα(h, w): represents an attribute function for attribute α

Various approaches for estimating suitable boundary values are known in the state of the art.

According to a known approach, the desired boundary value mα for the speech model is obtained by applying the attribute function fα to a training corpus and then smoothing the resultant frequencies. The smoothing can take place by subtracting a correction value from the calculated frequency N(α), for example.

According to a second, alternative method, the calculation is performed by reducing the quantities of attributes in the speech model until the boundary conditions no longer demonstrate conflicts. This sort of reduction in the quantity of attributes must be very extensive in practical situations, since otherwise the generated speech model will no longer represent a solution to the original training object.

Various definitions for the attribute function fα are known in the state of the art; it is normally defined, however, as:

$${f}_{α} ( h , w ) = \{ \begin{matrix}1 & if α correctly describes the string of words ( h , w ) \\ 0 & otherwise\end{matrix} \qquad ( 3 )$$

The n-th iteration boundary value m_{α}⁽ⁿ⁾ represents an iterative approximation for the desired boundary values mα defined above. The n-th iteration boundary value m_{α}⁽ⁿ⁾ is calculated as follows:

$${m}_{α}^{( n )} = {\sum }_{( h , w )} N ( h ) \cdot {p}^{( n )} ( w \vert h ) \cdot {f}_{α} ( h , w ) \qquad ( 4 )$$

This formula differs from formula (2) above simply by virtue of the fact that, for the probability p(w|h), an approximation in the form of the iteration value p(n)(w|h) is selected, where the iteration value p(n) is calculated as follows:

$$\begin{matrix}p ( n ) ( w \vert h ) = \frac{1}{{Z}^{( n )} ( h )} \cdot exp ( {\sum }_{α} {λ}_{α}^{( n )} \cdot {f}_{α} ( h , w ) ) & ( 5 ) \\ Z ( n ) ( h ) = {\sum }_{w} exp ( {\sum }_{α} {λ}_{α}^{( n )} \cdot {f}_{α} ( h , w ) ) & ( 6 )\end{matrix}$$

where Z(n)(h) and the free parameters λ_{α}⁽ⁿ⁾ are each trained (i.e. iteratively approximated) by the GIS training algorithm.

According to method step S1/4, a check should be made after each iteration step as to whether the calculated iteration boundary values m_{α}⁽ⁿ⁾ have already converged towards the desired boundary values mα with the desired accuracy. If this is the case, the method according to the invention is terminated.

If, however, this is still not the case, the attributes group Ai(n) with the greatest need for correction must be determined again before each incrementation of the iteration parameter by 1; the method according to the invention involves the method steps S1/5 to S1/7 described below which are carried out either for the first time or repeated.

According to method step S1/5, the criterion Dᵢ⁽ⁿ⁾ is calculated separately for each and every attribute group Ai in the speech model. This is a measure of how well the iteration values m_{α}⁽ⁿ⁾ for attributes α of group Ai are adapted to the various associated desired boundary values mα. The criterion is best described in mathematical form as follows:

$${D}_{i}^{( n )} = [ {\sum }_{αϵ {A}_{i}} {t}_{α} \cdot {m}_{α} log ( \frac{{m}_{α}}{{m}_{α}^{( n )}} ) + ( 1 - {\sum }_{αϵ {A}_{i}} {t}_{α} \cdot {m}_{α} ) log ( \frac{1 - \sum {t}_{α} \cdot {m}_{α}}{1 - \sum {t}_{α} \cdot {m}_{α}^{( n )}} ) ] \qquad ( 7 )$$

The convergence increment tα is calculated as follows:

$${t}_{α} = \frac{1}{{M}_{i}} with {M}_{i} = {max}_{( h , w )} ( {\sum }_{α ∈ {A}_{i}} {f}_{α} ( h , w ) ) \qquad ( 8 )$$

In the context of formula (7), it is important to note that the poorer the adaptation of the iterative boundary values m_{α}⁽ⁿ⁾ is to their associated desired boundary values mα for a specific attribute group Ai, the larger the value of Dᵢ⁽ⁿ⁾ becomes.

Consequently, the attribute group with the poorest adaptation, i.e. the one with the largest need for correction, is determined in accordance with method step S1/7 as:

$$i ( n ) = {a r g max}_{j} {D}_{j}^{( n )} \qquad ( 9 )$$

In method step S1/8, the attribute group Ai(n) with the largest need for correction that has thus been selected is used to calculate the n+1 iteration values for the free parameters λ in accordance with the state-of-the-art equation (1) described above. During the n-th iteration step, the equation (1) is calculated for all attributes α from the selected attribute group Ai(n) before the iteration parameter n is incremented by 1. The iteration values λ_{α}⁽ⁿ⁺¹⁾ are then calculated in accordance with an initial configuration of a mathematical function G( ) as follows:

$${λ}_{α}^{( n + 1 )} = G ( ) = {λ}_{α}^{( n )} + {t}_{α} \cdot log ( \frac{{m}_{α}}{{m}_{α}^{( n )}} \cdot \frac{1 - {\sum }_{β ∈ A i ( n )} {t}_{β} \cdot {m}_{β}^{( n )}}{1 - {\sum }_{β ∈ A i ( n )} {t}_{β} \cdot {m}_{β}} ) \qquad ( 10 )$$

This type of acyclical calculation of the iteration values λ_{α}⁽ⁿ⁺¹⁾ offers the advantage that unnecessary iteration steps can be avoided, and the convergence speed of the GIS training algorithm can be considerably improved.

After the iteration value λ_{α}⁽ⁿ⁺¹⁾ has been calculated, the iteration parameter n is redefined as n=n+1 in step S1/8.

The iteration value calculated in formula (8) and redefined in step S1/8 from λ_{α}⁽ⁿ⁺¹⁾ to λ_{α}⁽ⁿ⁾ is then reused to calculate the current iteration boundary value m_{α}⁽ⁿ⁾ in step S1/3, according to formula (4) in conjunction with formulae (5) and (6).

However, the convergence speed of the GIS training algorithm depends not only on the selection of a suitable attribute group for each iteration step n, but also on the attribute function used to calculate the convergence increments tα and tβ and the iterative boundary values m_{α}⁽ⁿ⁾ and m_{β}⁽ⁿ⁾. The convergence speed of the GIS training algorithm can also be increased by the fact that, instead of a normal attribute function as set out in formula (3), an orthogonalized attribute function ƒ_{α}^{ortho} is used which is defined as follows:

$${f}_{α}^{ortho} ( h , w ) = \{ \begin{matrix}1 & \begin{matrix}if α is the characteristic with the highest \\ range in Ai which correctly describes \\ the string of words ( h , w )\end{matrix} \\ 0 & otherwise\end{matrix} \qquad ( 11 )$$

When the orthogonalized attribute function ƒ_{α}^{ortho} is used instead of the normal attribute function fα in formulae (4), (5),(6) and (8), and when an additional calculation is made of the desired boundary values m_{α}^{ortho} and m_{β}^{ortho} through the application of the orthogonalized attribute function ƒ_{α}^{ortho} to a speech model training corpus, the formula for the GIS training algorithm (similar to formula (10)) is as follows:

$${λ}_{α}^{ortho ( n + 1 )} = {λ}_{α}^{ortho ( n )} + {t}_{α}^{ortho} \cdot log ( \frac{{m}_{α}^{ortho}}{{m}_{α}^{ortho ( n )}} \cdot \frac{1 - {\sum }_{βϵA i ( n )} {t}_{β}^{ortho} \cdot {m}_{β}^{ortho ( n )}}{1 - {\sum }_{βϵA i ( n )} {t}_{β}^{ortho} \cdot {m}_{β}^{ortho}} ) , \qquad ( 12 )$$

where ideally this formula is not calculated cyclically, but rather acyclically in accordance with the method described in FIG. 1. The right-hand side of the equation (12) describes a second version of the mathematical function G in patent claim 1.

The desired boundary values m_{α}^{ortho}, which should be approximated using iteration values m_{α}^{ortho(n)}, are best calculated using:

$${m}_{α}^{o r t h o} = {m}_{α} - {\sum }_{( * )} {m}_{β}^{o r t h o} \qquad ( 13 )$$

where (*) contains all higher-ranging attributes β which include the attribute α and which are in the same attribute group α. For calculating the boundary value m_{β}^{ortho}, this formula should be reused almost recursively for each attribute β, until the sum term disappears for certain attributes, i.e. for those with the highest ranges, since there are no higher-ranging attributes for these attributes. The required orthogonalized boundary values for the highest-ranging attributes βk then each correspond to the normal required boundary values mβk.

A method for the calculation of the desired orthogonalized boundary values m_{α}^{ortho} in accordance with formula (13) is described in FIGS. 2a and 2b.

As shown in FIGS. 2a and 2b, in an initial method step S2/1 in the speech model, all attributes βi, where i=1 . . . g, which demonstrate a higher range than an attribute α=β0, i.e. which include this at a predefined point and which come from the same attribute group as α, are calculated. In a subsequent method step S2/2, a desired boundary value mβi is calculated for all attributes βi, where i=0 . . . g, i.e. also for the attribute α=β0.

Various state-of-the-art methods are known for calculating the desired boundary value mβi, as described above in accordance with formula (2).

In method step S2/3 all attributes βi are then sorted according to their range, where ideally the index i=g is assigned to the attribute βi with the largest range. It may also be that multiple attributes βi are assigned to individual range classes, i.e. the bigram or trigram class. In these cases, multiple attributes βi with different but consecutive indices i are assigned to one and the same range class—i.e. these attributes then each have the same range.

For the method routine in the subsequent steps of which the individual attributes βi are evaluated in turn, it is important that a first run-through n=0 of the method be started with a attribute βi which is assigned to the highest range class. Ideally, therefore, the run-through will begin with attribute βg (see method steps S2/4 and S2/5 in FIG. 2a).

In a subsequent method steps (S2/6), a check is made as to whether, for the currently selected attribute βi (in the first run-through n=0 is i=g), there are any predefined higher-ranging attributes βk, where i<k<g, which include the attribute βi. During the first run-through, attribute βi, as stated above, automatically belongs to the class with the highest range, and therefore the query in method step S2/6 for this attribute βi should be negated. In this case, the method jumps to method step S2/8, where a parameter X is set to zero. There follows a calculation of an improved desired orthogonalized boundary value m_{βi}^{ortho} for the attribute βi in accordance with method step S2/9 as shown in FIG. 2b. As can be seen here, this boundary value for the attribute βi is equated to the desired boundary value mβi calculated in stage S2/2, if the parameter is X=0.

Method steps S2/5 to S2/11 are then repeated in sequence for all attributes βi-1, where i-1=g-1, g-2, . . . , 0. In method step S2/10, the desired re-initialization of the index i is carried out and in method step S2/11, a query is made as to whether all attributes βI, where i=0 . . . g, have been processed.

For all attributes βi, for which there are predefined higher-ranging attributes βk, where i<k≦g the query in method step S2/6 must be answered with “Yes”. The parameter X is then not set to zero, but is instead calculated according to method steps S2/7 by totaling the corresponding improved desired orthogonalized boundary values m_{βk}^{ortho} each calculated in previous run-throughs in method step S2/9) for the higher-ranging attributes βk in each case.

Once it has been determined in method step S2/11 that the desired orthogonalized boundary value m_{β0}^{ortho} has been calculated in method step S2/9, this is then output in method step S2/12 as m_{α}^{ortho}.

FIG. 3 shows a speech recognition system 10 of the type according to this invention which is based on the maximum entropy speech model. It includes a recognition device 12 which attempts to recognize the semantic content of supplied speech signals. The speech signals are generally supplied to the speech recognition system in the form of output signals from a microphone 20. The recognition device 12 recognizes the semantic content of the speech signals by mapping patterns in the received acoustic signal onto predefined recognition symbols such as specific words, actions or events, using the implemented maximum entropy speech model MESM. The recognition device 12 then outputs a signal which represents the semantic content recognized in the speech signal and which can be used to control all kinds of equipment—e.g. a word processing program or telephone.

To make the control of the equipment as error-free as possible in terms of the semantic content of speech information used as a control medium, the speech recognition system 10 must recognize the semantic content of the speech to be evaluated as correctly as possible. To do this, the speech model must be adapted as effectively as possible to the linguistic attributes of the speaker, i.e. the speech recognition system's user. This adaptation is performed by a training arrangement 14, which can be operated either externally or integrated into the speech recognition system 10. To be more accurate, the training arrangement 14 is used to adapt the MESM in the speech recognition system 10 to recurrent statistical patterns in the speech of a particular user.

Both the recognition device 12 and the training arrangement 14 are normally, although not necessarily, in the form of software modules and run on a suitable computer (not shown).

1. A method of calculating iteration values for free parameters λα in the maximum-entropy speech model in accordance with the following general training algorithm:
λ_{α}⁽ⁿ⁺¹⁾|_{αεAi(n)}=G(λ_{α}⁽ⁿ⁾,m_{α},m_{α}⁽ⁿ⁾, . . . )|_{αεAi(n)}
where:
n: refers to an iteration parameter that represents a current iteration step;
Ai: represents the i-th attributes group in the speech model, where 1≦i≦m;
Ai(n): represents the attributes group selected in the n-th iteration step;
α: represents a attribute in the speech model;
G: represents a mathematical function;
λ_{α}⁽ⁿ⁾: represents the n-th iteration value for the free parameter λα;
m_{α}: represents a desired boundary value for the attribute α; and
m_{α}⁽ⁿ⁾: represents the n-th iteration boundary value for the desired boundary value mα, where one attribute group Ai(n) from a total of m speech model attribute groups is assigned to each iteration parameter n, and where the iteration values λ_{α}⁽ⁿ⁺¹⁾ are calculated for each and every attribute α from the currently assigned attribute group Ai(n), characterized in that the current iteration parameter n is assigned the attribute group Ai(n), where 1≦i(n)≦m, for which, in accordance with a predefined criterion, the adaptation of the iteration boundary values m_{α}⁽ⁿ⁾ to the respective associated desired boundary values mα is the worst of all the m attribute groups of the speech model.

2. A method as claimed in claim 1, characterized in that the following steps for calculating and evaluating the criterion are included before each incrementation of the iteration parameter n:
a) Calculating current iteration boundary values m_{α}⁽ⁿ⁾ for attributes α from all the attribute groups Ai, where i≦i≦m, of the speech model according to the following formula:
$${m}_{α}^{( n )} = {\sum }_{( h , w )} N ( h ) \cdot {p}^{( n )} ( w \vert h ) \cdot {f}_{α} ( h , w )$$
where
N(h): describes the frequency with which the string of words h (history) occurs in a speech model-training corpus;
p(n) (w|h): is an iteration value for the probability with which the word w follows the history h
and
fα (h,w): represents an attribute function for the attribute α;
b) Selecting the attribute group Ai(n) for which the iteration boundary values m_{α}⁽ⁿ⁾ are most poorly adapted to the associated boundary values mα, by executing the following steps:
bi) for each attributes group Ai: Calculating the criterion Dᵢ⁽ⁿ⁾ according to the following formula:
$${D}_{i}^{( n )} = [ {\sum }_{α ∈ A i} {t}_{α} \cdot {m}_{α} \cdot log ( \frac{{m}_{α}}{{m}_{α}^{( n )}} ) + ( 1 - {\sum }_{α ∈ A i} {t}_{α} \cdot {m}_{α} ) ) \cdot log ( \frac{1 - {\sum }_{α ∈ A i} {t}_{α} \cdot {m}_{α} )}{1 - {\sum }_{α ∈ A i} {t}_{α} \cdot {m}_{α}^{( n )} )} ) ] ;$$
bii) Selecting the attribute group Ai(n) with the largest value for the criterion Dᵢ⁽ⁿ⁾ according to:
$$i ( n ) = {a r g max}_{j} {D}_{j}^{( n )} ; \qquad ( 7 )$$
biii) Updating the parameter λ_{α}⁽ⁿ⁺¹⁾ for all the attributes α from the selected attribute group Ai(n); and
c) Repeating steps a) and b) in each further iteration step, until all boundary values m_{α}⁽ⁿ⁺¹⁾ converge with a desired convergence accuracy.

3. A method as claimed in claim 2, characterized in that the following initialization steps are carried out before the first run-through of steps a)-c) of claim 2:
a′) Determining values for the convergence increments tα; and
a″) Initializing p(0)(w|h) with any set of parameters λ_{α}⁽⁰⁾.

4. A method as claimed in claim 3, characterized in that the values of the convergence increments tα for each attributes group Ai are calculated in step a′) as follows:
$${t}_{α} = \frac{1}{{M}_{i}} with {M}_{i} = {max}_{( h , w )} ( {\sum }_{αϵ {A}_{i}} {f}_{α} ( h , w ) )$$

5. A method as claimed in one of the above claims, characterized in that the function G represents a Generalized Iterative Scaling (GIS) training algorithm, and is defined as follows:
$${λ}_{α}^{( n + 1 )} = G = {λ}_{α}^{( n )} + {t}_{α} \cdot log ( \frac{{m}_{α}}{{m}_{α}^{( n )}} \cdot \frac{1 - {\sum }_{β ∈ A i ( n )} {t}_{β} \cdot {m}_{β}^{( n )}}{1 - {\sum }_{β ∈ A i ( n )} {t}_{β} \cdot {m}_{β}} ) ,$$
where α represents a specific attribute and β all the attributes from the selected attribute group Ai(n).

6. A method as claimed in one of claims 2 to 5, characterized in that the attribute function fα is an orthogonalized attribute function ƒ_{α}^{ortho}, which is defined as follows:
$${f}_{α}^{ortho} ( h , w ) = \{ \begin{matrix}1 & if α is the attribute with the highest range in Ai which \\ & correctly describes the string of words ( h , w ) \\ 0 & otherwise\end{matrix} .$$

7. A method as claimed in claim 6, characterized in that the desired orthogonalized boundry value m_{α}^{ortho} is calculated according to:
$${m}_{α}^{ortho} = {m}_{α} - {\sum }_{{(}^{*} )} {m}_{β}^{ortho}$$
where (*) contains all the higher ranging attributes β which include the attribute α and which come from the same attribute group as α.

8. A speech recognition system (10) comprising a recognition device (12) for recognizing the semantic content of an acoustic signal, in particular a voice signal, recorded by a microphone (20) and made available, by mapping parts of this signal onto predefined recognition symbols as supplied by the maximum entropy speech model MESM, and for generating output signals which represent the recognized semantic content; and a training arrangement 14 for adapting the MESM to recurring statistical patterns in the speech of a specific user of the speech recognition system (10), characterized in that the training arrangement 14 calculates free parameters λ in the MESM in accordance with the method as claimed in claim 1.

9. A training arrangement (14) for adapting the maximum entropy speech model (MESM) in a speech recognition system (10) to recurring statistical patterns in the speech of a specific user of the speech recognition system (10), characterized in that the training arrangement (14) calculates free parameters λ in the MESM in accordance with the method as claimed in claim 1.
